(19) United States
(12) Patent Application Publication
(10) Pub. No.: US 2008/0047790 A1
(43) Pub. Date: Feb. 28, 2008

(54) Brake Lining for a Disk Brake of a Vehicle, Particularly a Rail Vehicle

(76) Inventors: Gabriel Muller, Schwabmunchen (DE); Xaver Wirth, Ismaning (DE)

Correspondence Address: BARNES & THORNBURG LLP, 750-17TH STREET NW, SUITE 900, WASHINGTON, DC, 20006-4675, US

(21) Appl. No.: 11/630,830

(22) PCT Filed: Jun. 30, 2005
(86) PCT No.: PCT/EP05/07023

§ 371 Date: Aug. 1, 2007

(30) Foreign Application Priority Data
Jul. 1, 2004 (DE) 10 2004 031 791.7

(51) Int. Cl. F16D 65/092

(52) U.S. Cl. 188/250 B

(57) ABSTRACT

A brake lining for a disk brake of a vehicle includes a support plate and a plurality of friction elements coupled to the support plate. The plurality of friction elements each include a lining carrier and a friction lining coupled to the lining carrier.

### BACKGROUND AND SUMMARY

The present disclosure relates to a brake lining for a disk brake of a vehicle, and more particularly to a disk brake for a rail vehicle. The brake lining includes a support plate and a plurality of friction elements coupled to the support plate. The plurality of friction elements each include a lining carrier and a friction lining coupled to the lining carrier.

Brake linings of the above-mentioned type are known, for example, from EP 0 784 761 B1. In this case, each of the friction elements has a friction lining which frictionally engages the brake disk in the event of braking and is made of a sintered metal.

In principle, friction linings of sintered metal have considerable advantages in comparison to other, non-metallic friction linings. This relates, in particular, to high temperature resistance and avoidance of troublesome smell or smoke.

However, a disadvantage is that the sintered metals cause squeaking noises during brake operation. This is primarily as a result of the material connection to the support plate and by which the vibrations which generate the squeaking noises can be produced unimpeded.

These noises, which are extremely unpleasant for passengers, stand in the way of widespread introduction, especially in local passenger services.

Despite many attempts using material mixtures or design configurations of the friction linings, no satisfactory solutions which would make possible widespread acceptable use of metallic friction, linings have been found hitherto.

The present disclosure relates to a brake lining of a type such that its acceptance in use is improved.

The present disclosure thus relates to a brake lining for a disk brake of a vehicle. The brake lining includes a support plate and a plurality of friction elements coupled to the support plate. The plurality of friction elements each include a lining carrier and a friction lining coupled to the lining carrier. Further included is at least one damping element provided on at least one of the friction elements to one of interrupt and attenuate transmission of acoustic vibrations.

Thus, according to the present disclosure, a damping element is provided on at least one of the friction elements, and possibly on each friction element. The damping element is located between each friction element and the support plate in order to interrupt or attenuate the transmission of acoustic vibrations.

Such a design results in the friction elements being uncoupled from the support plate with respect to vibration. Surprisingly, it has been found that, as a result, the described unpleasant squeaking no longer occurs.

Sound-damping layers made, for example, of an elastomer, are known for brake linings of motor vehicles. Braking forces are in general not transmitted by these sound-damping layers. In addition, the use of such elements on the generic brake linings for rail vehicles, which comprise a plurality of friction elements having metallic lining carriers and individual sintered metal linings on a collective support plate, and which become very hot, has not been considered.

To this extent, the present disclosure relates to a brake lining which combines advantages of a non-metallic friction lining (avoidance of squeaking noises) with advantages of metallic friction linings. Such a brake lining may include friction linings of sintered metal, such as the aforementioned high temperature resistance and the absence of troublesome smell or smoke. The high temperature resistance is provided in conjunction with brake disks of steel or gray cast iron.

In order to transmit high lateral forces arising during the braking operation, the damping element is produced in the form of a damping layer made of suitably stressable materials. The following may be examples: textiles of high temperature resistant threads from which superposed individual layers woven into mats can be produced; layers of superposed thin metal sheets; layers of high-temperature papers, which are commercially available with a thermal resistance of up to 1200° C.; and, wire meshes. Elastomers do not appear suitable.

The damping layer may include a plurality of layers of different materials, such as thin preformed metal parts and damping layers that are laminated alternately.

The preformed metal parts are dimensioned such that their natural oscillation frequency corresponds approximately to the frequency of the brake lining, which causes the aforementioned squeaking noises. The oscillation amplitude excited is, so to speak, consumed by the adjacent damping layers, the vibration energy being thus “annulled”.

Depending on the thickness of the individual intermediate layers, up to 10 individual intermediate layers may be utilized. Between 1 and 5 intermediate layers may be preferably provided.

The preformed metal parts within a damping layer may be made of different materials, for example steel and copper. In this way, different natural frequencies are achieved using the same geometry.

What is important is that the damping layer is elastic or quasi-elastic in its behavior, in order to achieve damping of the vibrations which cause the squeaking.

Brake linings are also known from EP 0 837 260 B1 and from EP 0 784 761 B1 (already cited herein) and DE 197 09 962 C1.

In the herein disclosed brake linings, a part-spherical reverse side of the friction lining engages in corresponding dome-shaped recesses in the support plate. The sintered metal which forms the friction lining is connected to an element carrier plate having the protrusion in the form of a spherical segment.

This inner lining carrier plate has an outer connecting plate adapted thereto which is located in the dome-shaped recess, between which the damping layer is arranged for damping. This damping layer may be either inserted loosely or may be connected to one or both of the adjacent plates.

When a lining application force exerted by an application device, together with a tangential frictional force, act on the friction element during the braking operation, the resultant force is transmitted radially to the support plate by the spherical surfaces.

The quasi-elastic damping layer effects separation of the metal parts, with the result that the vibrations excited, which cause the squeaking, are damped.

However, even if the damping layer is omitted, damping of vibrations is achieved solely through the friction of the two element carrier plates bearing against one another.

In addition, the brake lining of the present disclosure is distinguished by simple construction. It is possible to retrofit brake linings already supplied and in extensive use. The operating principle of the brake lining of the present disclosure is not impaired by the laminated structure described.

The service life of associated components, for example disk springs with which the frictional elements are connected at the rear to the support plate, is increased by the thermally insulating effect of the damping layer, resulting in a very significant reduction in operating costs.

Other aspects of the present disclosure will become apparent from the following descriptions when considered in conjunction with the accompanying drawings.

### BRIEF DESCRIPTION OF THE DRAWINGS

FIG. 1 shows a top view of a portion of a brake lining, according to the present disclosure.

FIGS. 2 to 5 show sectional side views of different embodiments of a brake lining, according to the present disclosure.

### DETAILED DESCRIPTION

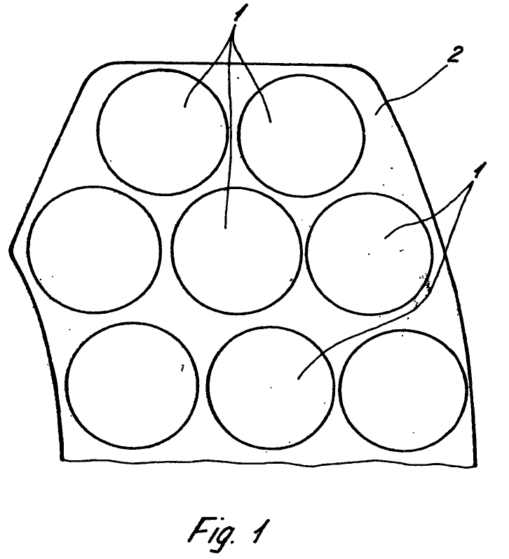

FIG. 1 shows a brake lining for a disk brake of a vehicle, for example, a rail vehicle. The brake lining includes a support plate 2 to which are fixed or coupled a plurality of friction elements 1, which friction elements 1 can be pressed against a friction surface of a brake disk (not shown) upon actuation of a brake. Each of the friction elements 1 includes a lining carrier 4, which may be metallic. Lining carrier 4 is connected to the support plate 1. A friction lining 3 is connected to the lining carrier 4.

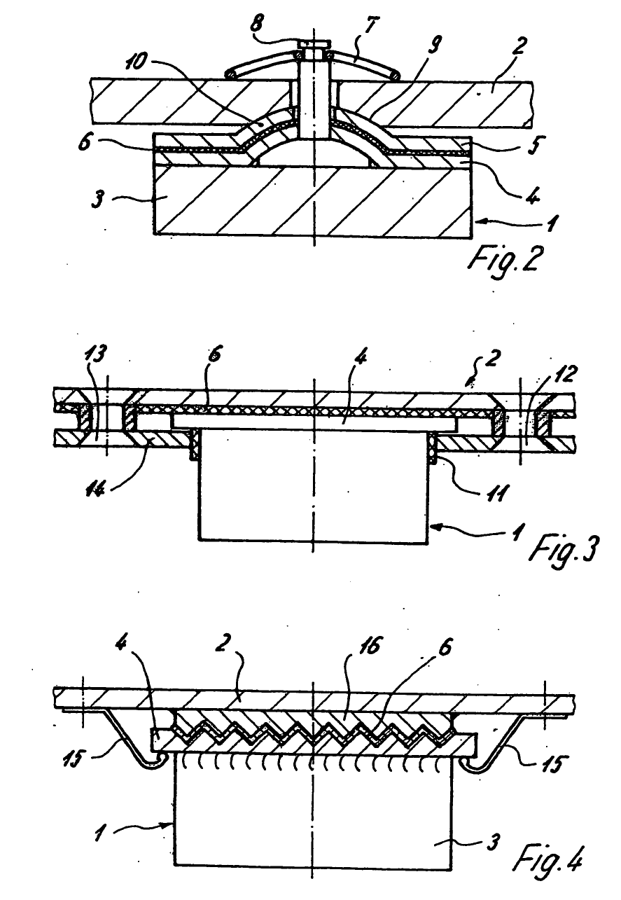

In the embodiment shown in FIG. 2, each friction element 1 is mounted tiltably on the support plate 2, for which purpose a connecting stud 8 is attached to the lining carrier 4. The connecting stud 8 passes through the support plate 2 and is retained to a rear thereof by a spring 7, for example a clip spring. Clip spring 7 bears against the support plate 2 and engages in the connecting stud 8.

To provide limited movement, the friction element 1 is mounted in a dome-shaped recess 9 of the support plate 2. The friction element 1 includes a spherical-segment-shaped protrusion 10 on its side facing towards the support plate 2.

The protrusion 10 engaging in the dome-shaped recess 9 of the support plate 2 is formed in a connecting plate 5. A cross-sectional contour of connecting plate 5 is adapted to that of the lining carrier 4.

Arranged between the connecting plate 5 and the lining carrier 4 is a damping layer 6. Damping layer 6 is connected to the connecting plate 5 and the lining carrier 4, and by which connection vibrations occurring during a braking operation are damped at least to the extent that no squeaking noises are produced.

Hitherto, the connecting plate 5 and the lining carrier 4, without the damping layer 6, formed a one-piece unit. Surprisingly, it has been found that even the material separation into the connecting plate 5 and the lining carrier 4 is enough to interrupt a sound bridge which forms in the one-piece unit or construction. However, optimum damping is achieved by including the damping layer 6.

FIG. 3 shows another embodiment in which the friction element 1 is retained on the support plate 2 by a mask plate 14. The mask plate 14 is connected to the support plate 2 by rivets 12, 13. The friction element 1 bears against the support plate 2. The damping layer 6 is arranged between the lining carrier 4, which holds the friction lining 3, and the support plate 2.

To avoid transmission of acoustic vibrations to the mask plate 14, and via the rivets 12, 13 to the support plate 2, a damping layer 11 is also arranged in a region in which the friction lining 3 passes through the mask plate 14. The damping layer 11 surrounds the friction lining 3 at least in an area covering the adjacent mask plate 14.

Depending on a requirement, the damping layers 6, 11 may be arranged loosely or may be connected firmly to adjacent components.

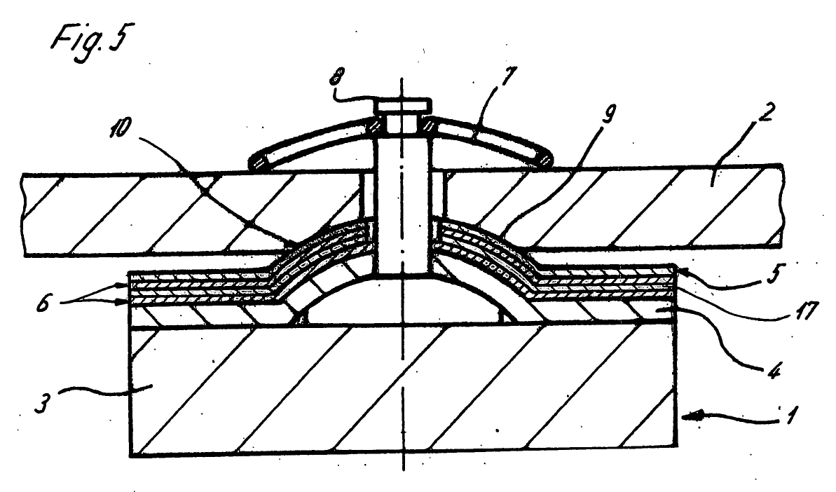

The same arrangement or connection applies to the damping layer 6, which is represented in an embodiment of a brake lining shown in FIG. 4.

In FIG. 4, it is shown that the friction element 1 is retained on the support plate 2 by retaining clips 15 which bear against the lining carrier 4 and are firmly connected to the support plate 2 at their other end.

In addition, the lining carrier 4 is provided, on its side facing away from the friction lining 3, with radial, parallel or concentric toothing which engages form-fittingly in a support 16 which is adapted to this contouring and is connected firmly to the support plate 2.

The damping layer 6 is inserted between the support 16 and the lining carrier 4. The damping layer 6 may be preformed to match the toothing. Alternatively, with a suitable selection of material of the damping layer 6, the forming may take place only as the friction element 1 and the support plate 2 are joined together.

The embodiment shown in FIG. 5 corresponds substantially to that represented in FIG. 2. In the embodiment of FIG. 5, however, a plurality, shown as two, damping layers 6 are spaced from one another and are separated by a metal plate 17 located between them.

Each of the damping layers, including those damping layers 6, 11 in the embodiments according to FIGS. 2 to 4, may include a plurality of layers of different materials, which may be formed, for example, of different metals. The metal plate 17 arranged between the two damping layers 6 may also be made of a material different from that of the connecting plate 5 and the lining carrier 4.

Although the present disclosure has been described and illustrated in detail, it is to be clearly understood that this is done by way of illustration and example only and is not to be taken by way of limitation. The scope of the present disclosure is to be limited only by the terms of the appended claims.

1. A brake lining for a disk brake of a vehicle, comprising:
a support plate;
a plurality of friction elements coupled to the support plate,
which plurality of friction elements each include a lining carrier and a friction lining coupled to the lining carrier; and
at least one damping element provided on at least one of the friction elements to one of interrupt and attenuate transmission of acoustic vibrations.

2. The brake lining of claim 1, wherein the at least one damping element is provided between one of the friction elements and the support plate to one of interrupt and attenuate the transmission of the acoustic vibrations.

3. The brake lining of claim 1, wherein the at least one damping element includes a vibration-damping, high temperature resistant damping layer.

4. The brake lining of claim 3, wherein the damping layer includes elastic material.

5. The brake lining of claim 3, wherein the damping layer includes one or more of high temperature resistant textiles and fibrous webs.

6. The brake lining of claim 3, wherein the damping layer includes a plurality of individual layers.

7. The brake lining of claim 3, wherein the damping layer includes a plurality of layers of different materials.

8. The brake lining of claim 3, wherein the damping layer includes two damping layers, and a metal plate is arranged between the two damping layers.

9. The brake lining of claim 8, wherein each damping layer includes at least one layer of a metal.

10. The brake lining of claim 9, wherein each metal layer is dimensioned such that its oscillation frequency corresponds approximately to a frequency of the brake lining which produces a squeaking noise.

11. The brake lining of claim 9, wherein each metal layer includes different materials.

12. The brake lining of claim 9, wherein each damping layer includes at least one layer.

13. The brake lining of claim 9, wherein each damping layer includes one or more of a) wire mesh, b) layers of thin sheet metal, c) textiles of high temperature resistant threads and d) high temperature resistant papers.

14. The brake lining of claim 1, wherein the at least one damping element includes a connecting plate with which at least one of the plurality of the friction elements abuts the support plate.

15. The brake lining of claim 3, wherein the damping layer is arranged between a lining carrier of a respective one of the plurality of friction elements and a connecting plate.

16. The brake lining of claim 3, wherein the damping layer is located between a lining carrier and a connecting plate.

17. The brake lining of claim 3, wherein the damping layer is connected to at least one of a lining carrier and a connecting plate.

18. The brake lining of claim 3, wherein the damping layer rests directly against a support plate and is fixed to the support plate.

19. The brake lining of claim 18, wherein the support plate associated with each friction element includes a support against which the friction element rests in a form-fittingly non-rotatable manner.

20. The brake lining of claim 19, wherein the support and an associated lining carrier of the friction element are provided with inter-engaging sets of toothing.

21. The brake lining of claim 20, wherein the damping layer is arranged between the sets of toothing.

22. The brake lining of claim 18, wherein each of the friction elements is retained on the support plate by a mask plate, and a damping layer is arranged between the lining carrier which holds the friction lining and the support plate, and the retaining of each of the friction elements occurs in an area in which the friction lining passes through the mask plate.

23. The brake lining of claim 1, wherein the lining carrier includes a metallic lining carrier.

24. The brake lining of claim 1, wherein the lining carrier includes sintered metal.

25. The brake lining of claim 9, wherein each damping layer includes up to ten individual layers.

26. The brake lining of claim 11, wherein the different materials include one or more of steel and copper.
